(19) United States
(12) Patent Application Publication
(10) Pub. No.: US 2014/0161176 A1
(43) Pub. Date: Jun. 12, 2014

(54) Method and Device for Controlling Video Quality Fluctuation Based on Scalable Video Coding

(71) Applicants: Peking University, Beijing (CN); Beijing Founder Electronics Co., Ltd., Beijing (CN); Peking University Founder Group Co., Ltd., Beijing (CN)

(72) Inventors: Jun Sun, Beijing (CN); Yilei Wang, Beijing (CN); Keji Chen, Beijing (CN); Zongming Guo, Beijing (CN)

(21) Appl. No.: 14/130,623

(22) PCT Filed: Jan. 4, 2013
(86) PCT No.: PCT/CN2013/070029

§ 371 Date: Jan. 2, 2014

(30) Foreign Application Priority Data
Jan. 4, 2012 (CN) 201210001318.2

(51) Int. Cl. H04N 19/31

(52) U.S. Cl. CPC H04N 19/0043
USPC 375/240.02

(57) ABSTRACT

Disclosed are a method and an apparatus for controlling video quality fluctuation based on scalable video coding. The method includes: performing scalable video coding on video data to be transmitted to generate a base layer and at least one enhancement layer; sending the video data after the scalable video coding to a terminal device; determining a currently expected bit rate according to a transmission status of the video data on a currently used channel, the currently expected bit rate being the maximum data transmission bit rate that the predicted currently used channel can sustain; acquiring the currently highest enhancement layer according to the currently expected bit rate, the sum of all bit rates occupied when transmitting video data under the currently highest enhancement layer being no larger than the currently expected bit rate; and sending the video data under the currently highest enhancement layer to the terminal device.

### FIELD OF THE INVENTION

This invention is related to the field of network video transmission, particularly to a method and an apparatus for controlling video quality fluctuation based on scalable video coding.

### BACKGROUND OF THE INVENTION

With the development of video transmission technology, the video transmission technology based on network bandwidth has become a mainstream one. Scalable video coding (SVC) is a common coding method among network video transmission technologies.

A video transmission device adopting SVC is capable of performing layered coding on a video signal, i.e., dividing the video signal in terms of time, space and quality, outputting multi-layered bit stream (including base layer and enhancement layer). Video playback devices are able to extract basic video contents by decoding the base layer, and the basic video contents can fulfill minimum conditions of video playback and user requirement on watching. However the video images obtained only from data of the base layer have lower frame rate, resolution and quality. When a channel is limited (the network bandwidth is small) or channel environment is complex (data transmission is unstable), transmission of only the base layer can ensure that a decoding end (video playback device) is capable of receiving relatively fluent video images. When the channel environment is good (data transmission is relatively stable) or the channel resource is abundant (network bandwidth is large), the enhancement layer data can be transmitted to improve frame rate, resolution and video quality. Meanwhile, there can be more than one enhancement layer, i.e., respective enhancement layers can be added to the base layer one by one to improve video quality in the situation that the maximum transmission bit rate of video signals that can be carried under the channel condition (network condition) is not exceeded.

During the transmission of video signals by the video transmission device adopting SVC, video quality fluctuation is one of the critical factors which affect the user experience. According to surveys, users prefer a video playback with more stable quality, i.e., a video playback with less fluctuated quality, to a video playback with sometimes-good-sometimes-bad quality. Therefore, the network video transmission device adopting SVC needs to control quality of video data according to specific condition of network bandwidth. A current method for controlling video quality fluctuation is a delaying feedback method of data packages, which is to adjust the video quality based on the delay occurred during the transmission process of data packages. It is required to monitor the transmission delay of the data packages having been sent, and make adjustments according to the monitored data after these data are received. The network video transmission device is required to send a set of data packages after there is a change occurred in the network bandwidth, and the transmission delay of this set of data packages is monitored followed by the adjustments according to this transmission delay.

Before proposing the present invention, the inventors found that there exist at least following problems in the prior arts:

Existing methods for controlling video quality fluctuation have more passive implementations because of the need to wait for the feedback of the transmission delay, which is not suitable for addressing the quality fluctuation caused by sudden changes of network bandwidth. In addition, the control of the video quality fluctuation has lower precision, and thus the user experience is not good.

### SUMMARY OF THE INVENTION

The present invention provides a method and an apparatus for controlling video quality fluctuation based on scalable video coding, which is capable of addressing the video quality fluctuation caused by sudden changes of bandwidth, and controlling the video quality fluctuation more precisely, so as to improve the user experience.

For achieving the above purposes, present invention adopts the following

### TECHNICAL SOLUTIONS

In one aspect, the present invention provides a method for controlling the video quality fluctuation, including:

performing the scalable video coding on video data to be transmitted, and generating one base layer and at least one enhancement layer;

sending the video data to be transmitted after the scalable video coding to a terminal device;

determining a currently expected bit rate according to the transmission status of the video data sent to the terminal device on a currently used channel, said currently expected bit rate being the predicted maximum data transmission bit rate that can be carried by the currently used channel;

acquiring a currently highest enhancement layer according to said currently expected bit rate, the sum of all bit rates occupied when transmitting the video data under said currently highest enhancement layer being no larger than said currently expected bit rate; and

sending the video data under said currently highest enhancement layer to the terminal device.

Preferably, the process of said determining the currently expected bit rate according to the transmission status of said video data to be transmitted on the currently used channel is periodical, the method for periodically determining the currently expected bit rate includes:

acquiring a data volume sent through the currently used channel within a set time;

acquiring a playback time according to the data volume sent within said set time, said playback time being a time duration of the video playback by the terminal device according to the video data sent within said set time; and

acquiring said currently expected bit rate according to said set time and said playback time.

Preferably, said acquiring the data volume sent through the currently used channel within the set time includes:

counting the sent data volume, and determining a counting start time; and

determining a current time, and acquiring the data volume sent within said set time, said set time being a period from said counting start time to said current time.

Preferably, said acquiring the currently expected bit rate according to the set time and the playback time includes:

acquiring a system output value according to the ratio of the set time to the playback time; and

acquiring the currently expected bit rate according to the system output value and a current data transmission bit rate.

Preferably, said acquired currently expected bit rate is the product of the system output value and the current data transmission bit rate.

Preferably, the video data under said currently highest enhancement layer includes: the sum of the video data corresponding to said currently highest enhancement layer, all the enhancement layers lower than said currently highest enhancement layer and the base layer.

Said method for acquiring the currently highest enhancement layer according to said currently expected bit rate includes:
1) extracting an enhancement layer with the lowest layer number from all the enhancement layers which have not been extracted;
2) acquiring the sum of the bit rates occupied when transmitting the sum of the video data corresponding to said base layer and all the extracted enhancement layers;
3) detecting whether the sum of said bit rates is larger than said currently expected bit rate or not;
if the sum of said bit rates is no larger than said currently expected bit rate, repeating the steps 1) to step 3) periodically until the sum of said bit rates is detected to be larger than said currently expected bit rate; and
4) if the sum of said bit rates is larger than said currently expected bit rate, the enhancement layer with the lowest layer number extracted from all the enhancement layers which have not been extracted in the last cycle is selected as the currently highest enhancement layer.

Preferably, in the method for acquiring the currently highest enhancement layer according to said currently expected bit rate, it further includes the following step before the step 1): setting the layer number of the enhancement layer with the lowest layer number among all the enhancement layers which have not been extracted as 1.

In another aspect, the present invention provides an apparatus for controlling video quality fluctuation, including:

a coding module, for performing the scalable video coding for video data to be transmitted, and generating one base layer and at least one enhancement layer;

a first transmitting module, for sending the video data to be transmitted after the scalable video coding to a terminal device;

an analysis module, for determining a currently expected bit rate according to the transmission status of the video data sent to the terminal device on a currently used channel, said currently expected bit rate is the predicted maximum data transmission bit rate that can be carried by the currently used channel;

an acquisition module, for acquiring a currently highest enhancement layer according to said currently expected bit rate, the sum of all bit rates occupied when transmitting the video data under said currently highest enhancement layer being no larger than said currently expected bit rate; and

a second transmitting module, for sending the video data under said currently highest enhancement layer to the terminal device.

Preferably, the process of determining by the analysis module the currently expected bit rate according to the transmission status of said video data to be transmitted on the currently used channel is periodical, and said analysis module includes:

a first acquisition unit, for acquiring a data volume sent through the currently used channel within a set time;

a second acquisition unit, for acquiring a playback time according to the data volume sent within said set time, said playback time being a time duration of the video playback by the terminal device according to the video data sent within said set time;

a third acquisition unit, for acquiring said currently expected bit rate according to said set time and said playback time.

Preferably, said first acquisition unit includes:

a first timing sub unit, for determining a counting start time during the process of counting the sent data volume;

a second timing sub unit, for determining a current time, said set time being a period from said counting start time to said current time; and

a counting sub unit, for acquiring the data volume sent within said set time.

Preferably, said third acquisition unit includes:

a first acquisition sub unit, for acquiring a system output value according to the ratio of the set time to the playback time; and

a second acquisition sub unit, for acquiring said currently expected bit rate according to said system output value and a current data transmission bit rate.

Preferably, said currently expected bit rate acquired by the second acquisition sub unit is the product of the system output value and the current data transmission bit rate.

Preferably, the video data under said currently highest enhancement layer includes: the sum of the video data corresponding to said currently highest enhancement layer, all the enhancement layers lower than said currently highest enhancement layer and the base layer;

Said acquisition module includes:

a first extracting unit, for extracting an enhancement layer with the lowest layer number from all the enhancement layers which have not been extracted;

a fourth acquisition unit, for acquiring the sum of the bit rates occupied when transmitting the sum of the video data corresponding to said base layer and all the extracted enhancement layers;

a detection unit, for detecting whether the sum of the bit rates is larger than said currently expected bit rate or not;

If the sum of said bit rates is no larger than said currently expected bit rate, the operations of the first extracting unit, the fourth acquisition unit and the detection unit are repeated periodically until the sum of said bit rates is detected to be larger than said currently expected bit rate; and

a second extracting unit, for selecting the enhancement layer with the lowest layer number extracted from all the enhancement layers which have not been extracted in the last cycle as the currently highest enhancement layer when the sum of said bit rates is larger than said currently expected bit rate.

Preferably, said acquisition module further includes:

an enhancement layer number setting module connected to the first extracting unit, for setting the layer number of the enhancement layer with the lowest layer number among all the enhancement layers which have not been extracted as 1.

The method and apparatus provided by the present invention for controlling video quality fluctuation based on the scalable video coding can monitor the data transmission status within the set time period during the process of sending the video data, and predict the maximum bit rate that can be carried by the currently used channel dynamically according to the specific monitoring results, and make corresponding adjustments to the currently highest enhancement layer that can be transmitted so as to control the video quality specifically. Compared with the prior arts, the present invention is able to actively anticipate changes of channel environment, and precisely adjust the transmitted video quality according to the specific condition of changes of network bandwidth, so as to address the video quality fluctuation caused by sudden changes of bandwidth, and control the video quality fluctuation more precisely to improve the user experience.

### BRIEF DESCRIPTION OF THE DRAWINGS

For illustrating the technical solutions of embodiments of the present invention more clearly, brief introductions to drawings used for the embodiments will be given in the following. Apparently, the drawings described below are merely a part of embodiments of the present invention, and other drawings can be obtained from these drawings for those skilled in the art without making creative efforts.

FIG. 1 is a flow chart of a method for controlling video quality fluctuation based on a scalable video coding according to the first embodiment of the present invention;

FIG. 2 is a flow chart of a method for controlling video quality fluctuation based on a scalable video coding according to the second embodiment of the present invention;

FIG. 3 is a flow chart of a specific example of the method for controlling video quality fluctuation based on the scalable video coding according to the second embodiment of the present invention;

FIG. 4 is a structure chart of an apparatus for controlling video quality fluctuation based on a scalable video coding according to the third embodiment of the present invention;

FIG. 5 is a structure chart of an apparatus for controlling video quality fluctuation based on a scalable video coding according to the fourth embodiment of the present invention;

### DETAILED DESCRIPTION OF THE EMBODIMENTS

In the following, clear and complete descriptions of the technical solutions of embodiments of the present invention will be given with reference to the appended drawings of embodiments of the present invention. Apparently, the described embodiments are merely a part of embodiments instead of all embodiments of the invention. All other embodiments based on the embodiments of the invention obtained by those skilled in the art without making creative efforts fall within the scope of protection of the present invention.

For clearer advantages of the technical solutions of the present invention, detailed descriptions of the present invention will be illustrated with reference to drawings and embodiments.

### The First Embodiment

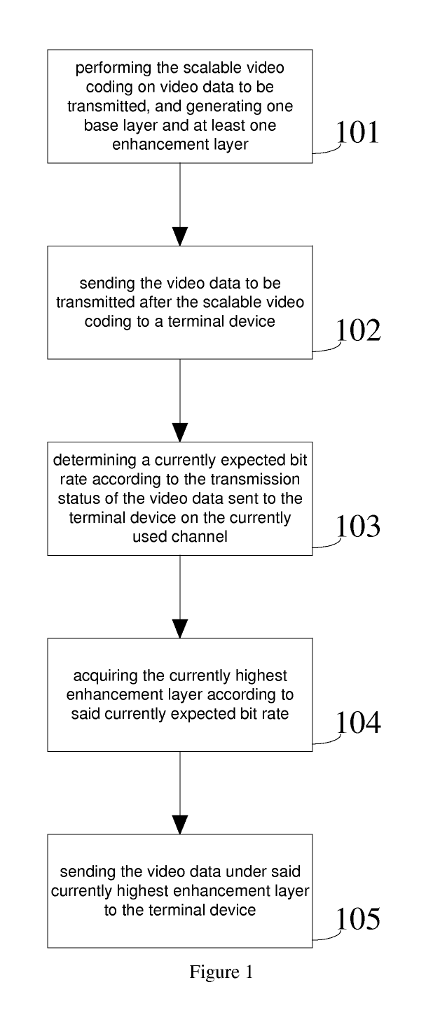

Embodiments of the invention provide a method for controlling video quality fluctuation based on scalable video coding, as shown in FIG. 1, the method includes:

Step 101, performing the scalable video coding on video data to be transmitted, and generating one base layer and at least one enhancement layer.

Specifically, in this embodiment, a video transmission device adopting the scalable video coding performs the scalable video coding on the video data to be sent, and the video data can be encoded into one base layer and at least one enhancement layer. Wherein, detailed implementation of performing the scalable video coding on the video data has been well known to those skilled in the art, and will not be further explained herein.

Step 102, sending the video data to be transmitted after the scalable video coding to a terminal device.

Specifically, in this embodiment, the video transmission device adopting the scalable video coding sends the video data after the scalable video coding to the terminal device, wherein in the embodiments of the invention, the implementation manner of sending the video data is not limited, and it can be any known implementation to those skilled in the art.

It is to be illustrated that, the video data sent in this step are not necessarily all of the video data corresponding to the base layer and all the enhancement layers generated in the step 101, but with only a part of them selectively sent. For example, only the video data corresponding to the base layer can be sent, or the sum of the video data corresponding to the base layer and a part of the enhancement layers can also be sent. However, skipping level is not allowed, in other words the base layer has to be selected, and the numbers of the enhancement layers need to be selected from the very beginning in the manner of continuous distribution from low to high when selecting a plurality of the enhancement layers. For example when three enhancement layers are selected, only the enhancement layer 1 to the enhancement layer 3 can be selected. Those skilled in the art can decide the specific amount of the enhancement layers to be selected by themselves according to the condition of the currently used channel.

Step 103, determining a currently expected bit rate according to the transmission status of the video data sent to the terminal device on the currently used channel.

Wherein, said currently expected bit rate is a predicted maximum data transmission bit rate that can be carried by the currently used channel.

Specifically, in this embodiment, the video transmission device adopting the scalable video coding can acquire the maximum data transmission bit rate that can be carried by the currently used channel according to the transmission status of the video data on the currently used channel by way of adopting PID (Proportion Integration Differentiation) automatic control method.

Step 104, acquiring the currently highest enhancement layer according to said currently expected bit rate.

Wherein, the sum of all bit rates occupied when transmitting the video data under said currently highest enhancement layer (i.e. the video data corresponding to said currently highest enhancement layer, the enhancement layers below it and the base layer) is no larger than said currently expected bit rate.

Specifically, in this embodiment, the sum of all bit rates occupied when the video transmission device adopting the scalable video coding transmits the video data under the currently highest enhancement layer is no larger than said currently expected bit rate.

The video data under said currently highest enhancement layer include: the sum of video data corresponding to said currently highest enhancement layer, video data corresponding to all the enhancement layers lower than said currently highest enhancement layer, and video data corresponding to said base layer.

Optionally, acquiring the currently highest enhancement layer according to said currently expected bit rate includes the following steps:

Step 104-1, extracting an enhancement layer with the lowest layer number (i.e., the lowest level) from all the enhancement layers which have not been extracted;

Step 104-2, acquiring the sum of the bit rates occupied when transmitting the sum of the video data corresponding to said base layer and all the extracted enhancement layers;

Step 104-3, determining whether the sum of said bit rates is larger than said currently expected bit rate;

Step 104-4, if the sum of said bit rates is no larger than said currently expected bit rate, repeating the steps 104-1 to 104-3 periodically until the sum of said bit rates is detected to be larger than said currently expected bit rate;

If the sum of said bit rates is larger than said currently expected bit rate, the enhancement layer with the lowest layer number extracted from all the enhancement layers which have not been extracted in the last cycle (i.e., the next-to-last extracted enhancement layer) is selected as the currently highest enhancement layer.

In other words, respective enhancement layers can be overlaid onto the base layer one by one, and the sum of the bit rate occupied when transmitting the video data after each overlay is respectively acquired and compared with the currently expected bit rate in turn. If there is one time that the sum of the bit rate occupied when transmitting the video data after each overlay is larger than the currently expected bit rate, the enhancement layer overlaid last time (i.e., the time before said “one time” above) is said currently highest enhancement layer (i.e., the next-to-last overlaid enhancement layer).

Step 105, sending the video data under said currently highest enhancement layer to the terminal device.

Specifically, in this embodiment, the video transmission device adopting the scalable video coding sends the video data to be transmitted subsequently (i.e., the next segment of video data to be transmitted) corresponding to said currently highest enhancement layer, all the enhancement layers lower than said currently highest enhancement layer, and the base layer (i.e., under the currently highest enhancement layer) to the terminal device. The implementation of sending the video data herein is consistent with that of the step 102 and therefore will not be described in detail.

It can be seen that, performing steps 103 to 105 is determining the currently expected bit rate according to the transmission status of the video data sent to the terminal device on a currently used channel, acquiring the currently highest enhancement layer according to said currently expected bit rate, and sending the video data under said currently highest enhancement layer as the video data to be transmitted subsequently to the terminal device. Further, repeating steps 103 to 105 can realize: determining the expected bit rate when transmitting the previous segment of video data according to the transmission status of the previous segment of the video data to be transmitted sent to the terminal device on the used channel (i.e., the maximum data transmission bit rate that can be carried by the used channel when transmitting the video data of the previous segment), acquiring the corresponding highest enhancement layer according to the expected bit rate, and sending the video data under this corresponding highest enhancement layer as the video data to be transmitted of next segment to the terminal device. Cycles are repeated in this way to achieve the purpose of video quality adjustment in real time.

The method for controlling video quality fluctuation based on the scalable video coding provided by the present invention is capable of monitoring the transmission status of the video data in real time during the process of sending the video data, and predicting the maximum bit rate that can be carried by the currently used channel according to the detailed monitoring results, and making corresponding adjustments to the currently highest enhancement layer that can be transmitted, so as to control the video quality specifically. Compared with the prior arts, the present invention is able to actively anticipate changes of channel environment, and precisely adjust the transmitted video quality according to the specific condition of changes of network bandwidth, so as to address the video quality fluctuation caused by sudden changes of bandwidth, and control the video quality fluctuation more precisely to improve the user experience.

### The Second Embodiment

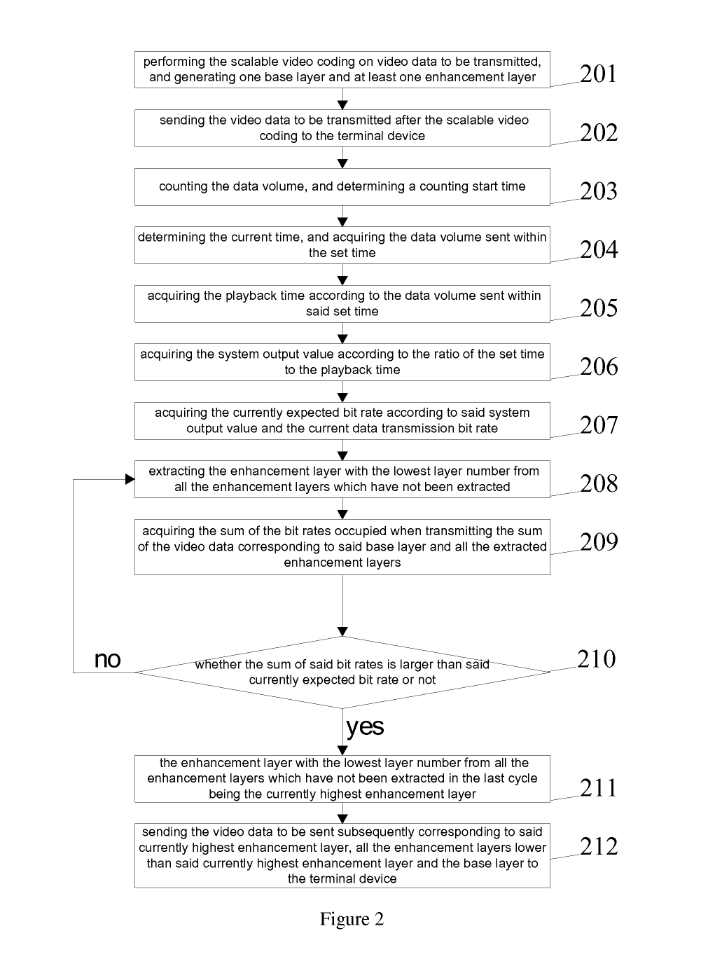

Embodiments of the present invention provide a method for controlling video quality fluctuation based on the scalable video coding, as shown in FIG. 2, the method includes:

Step 201, performing the scalable video coding on video data to be transmitted, and generating one base layer and at least one enhancement layer.

Specifically, in this embodiment, a video transmission device adopting the scalable video coding performs the scalable video coding on the video data to be sent, the video data can be encoded into one base layer and at least one enhancement layer. For example: as shown in Table 1

TABLE 1

| Layer number | 0 | 1 | 2 | 3 | 4 | 5 | 6 | 7 |
|---|---|---|---|---|---|---|---|---|
| Resolution | 0 | 0 | 0 | 0 | 1 | 1 | 1 | 1 |
| SNR | 0 | 0 | 1 | 1 | 0 | 0 | 1 | 1 |
| Frame rate | 0 | 1 | 0 | 1 | 0 | 1 | 0 | 1 |

The layer of number 0 is the base layer; the layers of number 1, 2, 3, 4, 5, 6, and 7 are the enhancement layers (enhancement layer 1 to 7, respectively). Each enhancement layer is enhanced based on the last enhancement layer in terms of at least one of frame rate, image resolution and signal-to-noise ratio (SNR) of the video data. 0 stands for no enhancement compared with the last layer, 1 stands for enhancement compared with the last layer. For example, the enhancement layer 2 is enhanced in terms of SNR of the video data compared with the enhancement layer 1, but not enhanced in terms of resolution and frame rate compared with the enhancement layer 1. It can be seen that in SVC, the base layer remains the lowest level in all three aspects of frame rate, image resolution and SNR for ensuring a basic playback performance of video, and the enhancement of quality of video images relies on the overlay of enhancement layers onto the base layer.

Wherein, the implementation of performing the scalable video coding on the video data is already well known to those skilled in the art and therefore will not be described in detail.

Step 202, sending the video data to be transmitted after the scalable video coding to the terminal device.

Specifically, in this embodiment, the video transmission device adopting the scalable video coding sends the video data after the scalable video coding to the terminal device. In the embodiment of the present invention, the implementation of sending the video data is not limited, but can be any implementation manner known to those skilled in the art.

It should be illustrated that, the video data sent in this step are not necessarily the sum of the video data corresponding to the base layer and all the enhancement layers generated in the step 201, but with only a part of them selectively sent. For example, only the video data corresponding to the base layer can be sent, or the sum of the video data corresponding to the base layer and a part of the enhancement layers can also be sent. However, it is not allowed to skip level, in other words the base layer has to be selected, and the numbers of the enhancement layers need to be selected from the very beginning in the manner of continuous distribution from low to high when selecting a plurality of the enhancement layers. For example when three enhancement layers are selected, only the enhancement layer 1 to the enhancement layer 3 can be selected. Those skilled in the art can decide the specific amount of the enhancement layers to be selected by themselves according to the condition of the currently used channel.

Step 203, counting the data volume, and determining a counting start time.

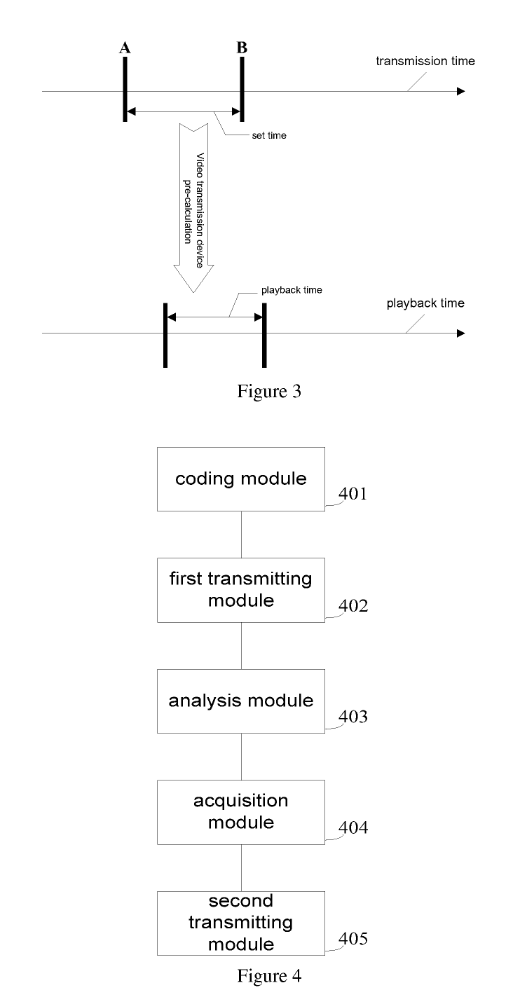

Specifically, in this embodiment, the video transmission device adopting the scalable video coding can count the sent data volume starting from one point of time (i.e. said counting start time) while sending the video data. For example, as shown in FIG. 3, the video transmission device can count the data volume from the time point A.

Step 204, determining the current time, and acquiring the data volume sent within the set time.

Wherein, said set time is a period from said counting start time to said current time.

Specifically, as shown in FIG. 3, the video transmission device adopting the scalable video coding can start counting the sent data volume at the time point A. The specific way of counting the data volume can be monitoring the amount of data packages of the video data sent by the video transmission device. After the set time, the monitoring is stopped at the time point B, and the total amount of the data packages of the video data sent within the set time is recorded so as to obtain the data volume sent within the set time.

Step 205, acquiring the playback time according to the data volume sent within said set time.

Wherein, said playback time is a time period that the terminal device plays the video according to the video data sent by the video transmission device adopting the scalable video coding within said set time.

Specifically, in this embodiment, the video transmission device adopting the scalable video coding can calculate an estimated playback time that the terminal device at the receiving end can play the video upon the video data of the data volume in accordance with these data volume of video data sent within the set time. Wherein, the implementation of acquiring the playback time according to said data volume is well known to those skilled in the art and therefore will not be described in detail.

Further, during the transmission of the video data, the video transmission device adopting the scalable video coding can repeat the processes of method from the steps 203 to 205 during transmission periodically, and record the set time and playback time gained in each cycle. Wherein, the time interval between adjacent cycles can be automatically set by the video transmission device in accordance with specific conditions or also set by the technical personnel manually, and will not be defined herein.

Step 206, acquiring the system output value according to the ratio of the set time to the playback time.

Specifically, in this embodiment, the video transmission device adopting the scalable video coding can acquire the system output value according to the set time and the playback time. The possible specific method can be as follows:

The video transmission device adopting the scalable video coding can acquire the system output value by a PID automatic control method, for example:

System output value=proportional coefficient*proportional part+integral coefficient*integral part+differential coefficient*differential part

Wherein, the proportional part=control variable=set time/playback time

In the PID automatic control method, the function of the proportional part is to predict the matching degree between the current network bandwidth and transmission status so as to drive the controlling results of the video quality fluctuation to approach the target condition successively according to the present invention.

The integral part=accumulated set time/accumulated playback time

Wherein, the accumulated set time or accumulated playback time is the sum of the set time or playback time of all cycles from the point of time when firstly acquiring the cycle of the playback time performed by the video transmission device to the current point of time. For example, 3 complete cycles have elapsed (i.e., in each cycle the method processes from steps 203 to 205 are performed completely) until the current point of time, and the set time and playback time of each cycle are respectively: 10 sec, 8 sec; 10 sec, 9 sec; 10 sec, 7 sec. As a result, the accumulated set time is 30 sec and the accumulated playback time is 24 sec, where the integral part=accumulated set time/accumulated playback time=30 sec/24 sec=1.25.

In the PID automatic control method, the function of the integral part is to monitor data for a long period in order to acquire the change condition of bandwidth on average within a relatively long time period, thereby reducing the possibility of quality fluctuation.

The differential part=control variable of this time/control variable of last time

Wherein, the control variable of this time is the control variable acquired upon the set time and playback time in this cycle (i.e., the current control variable=the set time in current cycle/the playback time in current cycle); the control variable of last time is the control variable acquired upon the set time and playback time in last cycle (i.e., the last control variable=the set time in last cycle/the playback time in last cycle).

In the PID automatic control method, the function of the differential part is to predict the change trend of bandwidth, thereby enabling the control variable to approach the target condition as soon as possible.

The detailed method for acquiring the proportional coefficient, integral coefficient and differential coefficient can be as follows: firstly, the video transmission device automatically set the integral coefficient and the differential coefficient as 0 (i.e., only the proportional item is left) after the video transmission device adopting the scalable video coding is powered on; then the proportional coefficient is adjusted to allow for a periodical change of the system output values (or approximately periodical change). Assuming the change period of the system output values is T (said period is a distribution period of the system output value) and the proportional coefficient is K, the final proportional coefficient (i.e., obtained after normal operation of the video transmission device) is 0.6K, the integral coefficient is 2K/T, and the differential coefficient is K*T/8. Wherein, detailed implementations for acquiring the proportional coefficient, integral coefficient and differential coefficient are well known to those skilled in the art and therefore will not be described in detail.

Step 207, acquiring the currently expected bit rate according to said system output value and the current data transmission bit rate.

Wherein, said acquired currently expected bit rate is the maximum data transmission bit rate that can be carried by the currently used channel.

Specifically, in this embodiment, the video transmission device adopting the scalable video coding acquires said currently expected bit rate according to the system output value and the current data transmission bit rate (i.e., the data transmission bit rate of the currently used channel). Wherein, the method for acquiring the current data transmission bit rate can be any one that those skilled in the art are familiar with and therefore will not be defined herein.

Wherein, the currently expected bit rate=system output value*current data transmission bit rate

Step 208, extracting the enhancement layer with the lowest layer number (i.e., the lowest level) from all the enhancement layers which have not been extracted.

Specifically, in this embodiment, the video transmission device adopting the scalable video coding extracts the enhancement layer with the lowest layer number from all the enhancement layers which have not been extracted as shown in Table 1. For example, if there is no enhancement layer extracted currently, the enhancement layer 1 is extracted; if the enhancement layer 1 and the enhancement layer 2 have been extracted currently, the enhancement layer 3 is extracted.

Step 209, acquiring the sum of the bit rates occupied when transmitting the sum of the video data corresponding to said base layer and all the extracted enhancement layers.

Specifically, in this embodiment, the extracted enhancement layers can be overlaid onto the base layer one by one by the video transmission device adopting the scalable video coding, and the sum of the bit rates occupied during transmission of the overlaid video data is acquired.

Step 210, detecting whether the sum of said bit rates is larger than said currently expected bit rate or not.

Wherein, the processes of the steps 208 to 210 are repeated periodically if the sum of said bit rates is no larger than the currently expected bit rate, and step 211 is not performed until the sum of said bit rates is detected to be larger than the currently expected bit rate.

Step 211, if the sum of said bit rates is larger than the currently expected bit rate, the enhancement layer with the lowest layer number (i.e., the next-to-last extracted enhancement layer) from all the enhancement layers which have not been extracted in the last cycle (i.e., the processes of performing the steps 208 to 210 of last time) being the currently highest enhancement layer.

Wherein, the sum of all the bit rates occupied when transmitting the sum of the video data corresponding to said currently highest enhancement layer, all the enhancement layers lower than said currently highest enhancement layer and the base layer is no larger than said currently expected bit rate.

For example, as shown in Table 1, after overlaying the enhancement layers 1 to 3 (the enhancement layer 3 is the enhancement layer with the lowest layer number within all the enhancement layers which have not been extracted in current cycle) to the base layer, if the sum of the bit rates occupied by the overlaid video data during transmission is larger than the currently expected bit rate, the currently highest enhancement layer is the enhancement layer 2 (the enhancement layer 2 is the enhancement layer with the lowest layer number within all the enhancement layers which have not been extracted in previous cycle).

Step 212, sending the video data to be sent subsequently corresponding to said currently highest enhancement layer, all the enhancement layers lower than said currently highest enhancement layer and the base layer to the terminal device.

Specifically, in this embodiment, the video transmission device adopting the scalable video coding sends the video data to be sent subsequently (i.e., the next segment of the video data to be transmitted) corresponding to said currently highest enhancement layer, all the enhancement layers lower than said currently highest enhancement layer and the base layer to the terminal device, the implementation of sending the video data is consistent with that in the step 102 and therefore will not be described in detail.

Further, repeating the steps 203 to 212 can realize: counting the data volume of the video data of previous segment to be transmitted sent the terminal device so as to acquire the corresponding set time and playback time, such that the system output value corresponding to the set time and the playback time is acquired; acquiring the corresponding expected bit rate according to said system output value and the data transmission bit rate of the currently used channel (this expected bit rate is the maximum data transmission bit rate that can be carried by the used channel when sending the video data of previous segment); acquiring the corresponding highest enhancement layer according to this expected bit rate; and sending the video data under the corresponding highest enhancement layer, which act as the video data of next segment to be transmitted, to the terminal device. Cycles are repeated in this way to achieve the purpose of video quality adjustment in real time.

It is to be illustrated that, when repeating the steps 203 to 212, it needs to add the following steps between the step 207 and the step 208: setting the layer number of the enhancement layer with the lowest layer number from all the enhancement layers which have not been extracted as 1, i.e., setting the layer number of the enhancement layer with the lowest layer number from all the enhancement layers which have not been extracted as the enhancement layer 1 so as to clear the layer number of the enhancement layer extracted by the step 208 in the last cycle (i.e., the last time performing the steps 203 to 212) to prevent the situation that the highest enhancement layer corresponding to the video data of next segment to be transmitted cannot be effectively acquired if the current channel condition when sending the video data of next segment is worse than that when sending the video data of previous segment.

The method for controlling video quality fluctuation based on the scalable video coding provided by the present invention is capable of monitoring the transmission status of the video data in real time during the process of sending the video data, and dynamically predicting the maximum bit rate that can be carried by the currently used channel according to the detailed monitoring results, and making corresponding adjustments to the currently highest enhancement layer that can be transmitted, so as to control the video quality specifically. Compared with the prior arts, the embodiment of the present invention is able to actively anticipate changes of channel environment, and precisely adjust the transmitted video quality according to the specific condition of changes of network bandwidth, so as to address the video quality fluctuation caused by sudden changes of bandwidth, and control the video quality fluctuation more precisely to improve the user experience.

### The Third Embodiment

Embodiments of the present invention provide an apparatus for controlling video quality fluctuation based on the scalable video coding, as shown in FIG. 4, this apparatus includes: a coding module 401, a first transmitting module 402, an analysis module 403, an acquisition module 404, a second transmitting module 405.

The coding module 401 is used for performing the scalable video coding on video data to be transmitted and generating one base layer and at least one enhancement layer.

The first transmitting module 402 is used for sending the video data to be transmitted after the scalable video coding to a terminal device.

It is to be illustrated that, the video data sent by the first transmitting module 402 to the terminal device are not necessarily the sum of the video data corresponding to the base layer and all the enhancement layers generated by the coding module 401, but with only a part of them selectively sent. For example, only the video data corresponding to the base layer can be sent, or the sum of the video data corresponding to the base layer and a part of the enhancement layers can also be sent. However, it is not allowed to skip level, in other words the base layer has to be selected, and the numbers of the enhancement layers need to be selected from the very beginning in the manner of continuous distribution from low to high when selecting a plurality of the enhancement layers. For example when three enhancement layers are selected, only the enhancement layer 1 to the enhancement layer 3 can be selected. Those skilled in the art can decide the specific number of the enhancement layers to be selected by themselves according to the condition of the currently used channel.

The analysis module 403 is used for determining a currently expected bit rate according to the transmission status of the video data sent by the first transmitting module 402 to the terminal device on the currently used channel.

Wherein, said currently expected bit rate is the predicted maximum data transmission bit rate that can be carried by the currently used channel.

The acquisition module 404 is used for acquiring the currently highest enhancement layer according to said currently expected bit rate determined by the analysis module 403.

Wherein, the sum of all bit rates occupied when transmitting the video data under said currently highest enhancement layer is no larger than said currently expected bit rate.

The second transmitting module 405 is used for sending the video data under said currently highest enhancement layer acquired by the acquisition module 404.

Then, the analysis module 403 determines the currently expected bit rate according to the transmission status of the video data sent by the second transmitting module 405 to the terminal device on the currently used channel; The acquisition module 404 acquires the currently highest enhancement layer according to said currently expected bit rate determined by the analysis module 403; The second transmitting module 405 sends the video data under said currently highest enhancement layer acquired by the acquisition module 404 to the terminal device. Cycles are repeated in this way to achieve the purpose of video quality adjustment in real time.

The apparatus for controlling video quality fluctuation based on the scalable video coding provided by the embodiment of the present invention is capable of monitoring the transmission status of the video data in real time during the process of sending the video data, and dynamically predicting the maximum bit rate that can be carried by the currently used channel according to the detailed monitoring results, and making corresponding adjustments to the currently highest enhancement layer that can be transmitted, so as to control the video quality specifically. Compared with the prior arts, the embodiment of the present invention is able to actively anticipate changes of channel environment, and precisely adjust the transmitted video quality according to the specific condition of changes of network bandwidth, so as to address the video quality fluctuation caused by sudden changes of bandwidth, and control the video quality fluctuation more precisely to improve the user experience.

### The Fourth Embodiment

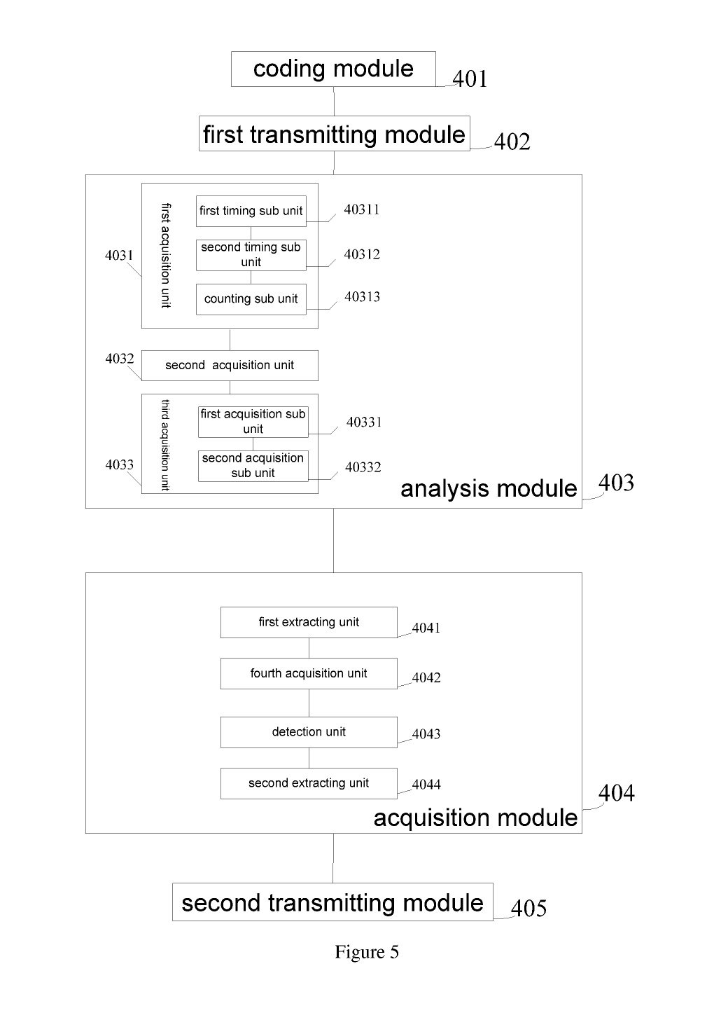

Embodiments of the present invention provide an apparatus for controlling video quality fluctuation based on the scalable video coding, as shown in FIG. 5. This apparatus includes: the coding module 401, the first transmitting module 402, the analysis module 403, the acquisition module 404, the second transmitting module 405, wherein the analysis module 403 includes: a first acquisition unit 4031, a second acquisition unit 4032, a third acquisition unit 4033, wherein the acquisition unit 4031 includes: a first timing sub unit 40311, a second timing sub unit 40312, a counting sub unit 40313; the third acquisition unit 4033 includes: a first acquisition sub unit 40331, a second acquisition sub unit 40332; and the acquisition module 404 includes: a first extracting unit 4041, a fourth acquisition unit 4042, a detection unit 4043, a second extracting unit 4044.

The coding module 401 is used for performing the scalable video coding on video data to be transmitted and generating one base layer and at least one enhancement layer.

The first transmitting module 402 is used for sending the video data to be transmitted after the scalable video coding to a terminal device.

It is to be illustrated that, the video data sent by the first transmitting module 402 to the terminal device are not necessarily all of the video data corresponding to the base layer and all the enhancement layers generated by the coding module 401, but with only a part of them selectively sent. For example, only the video data corresponding to the base layer can be sent, or the sum of the video data corresponding to the base layer and a part of the enhancement layers can also be sent. However, it is not allowed to skip level, in other words the base layer has to be selected, and the numbers of the enhancement layers need to be selected from the very beginning in the manner of continuous distribution from low to high when selecting a plurality of the enhancement layers. For example when three enhancement layers are selected, only the enhancement layer 1 to the enhancement layer 3 can be selected. Those skilled in the art can decide the specific amount of the enhancement layers to be selected by themselves according to the condition of the currently used channel.

The analysis module 403 is used for determining a currently expected bit rate according to the transmission status of the video data sent by the first transmitting module 402 to the terminal device on the currently used channel.

Wherein, said currently expected bit rate is the maximum data transmission bit rate that can be carried by the predicted currently used channel.

The first acquisition unit 4031 is used for acquiring a data volume sent through the currently used channel within a set time.

Wherein, the first acquisition unit 4031 includes:

the first timing sub unit 40311 used for determining a counting start time during the process of counting the data volume sent by the first transmitting module 402;

the second timing sub unit 40312 used for determining a current time, said set time being a period from said counting start time to said current time;

the counting sub unit 40313 used for acquiring the data volume sent within said set time;

the second acquisition unit 4032 used for acquiring a playback time according to the data volume sent within said set time, said playback time being a time duration of the video playback by the terminal device according to the video data sent by the first transmitting module 402 within said set time;

the third acquisition unit 4033 used for acquiring said currently expected bit rate according to said set time and said playback time.

Wherein, the third acquisition unit 4033 includes:

the first acquisition sub unit 40331 used for acquiring a system output value according to the ratio of the set time to the playback time; and

the second acquisition sub unit 40332 used for acquiring said currently expected bit rate according to said system output value and current data transmission bit rate.

The acquisition module 404 is used for acquiring the currently highest enhancement layer according to said currently expected bit rate acquired by the third acquisition unit 4033.

Wherein, the sum of all bit rates occupied when transmitting the video data under said currently highest enhancement layer is no larger than said currently expected bit rate.

Wherein, the acquisition module 404 includes:

the first extracting unit 4041 is used for extracting an enhancement layer with the lowest layer number from all the enhancement layers which have not been extracted;

the fourth acquisition unit 4042 used for acquiring the sum of the bit rates occupied when transmitting the sum of the video data corresponding to said base layer and all the extracted enhancement layers;

the detection unit 4043 used for detecting whether the sum of the bit rates is larger than said currently expected bit rate or not;

If the sum of said bit rates is no larger than said currently expected bit rate, above processes are repeated (i.e., the operations of the first extracting unit 4041, the fourth acquisition unit 4042 and the detection unit 4043 are repeated periodically) until the sum of said bit rates is detected to be larger than said currently expected bit rate.

the second extracting unit 4044 used for selecting the enhancement layer with the lowest layer number extracted from all the enhancement layers which have not been extracted (i.e., the next-to-last extracted enhancement layer) in the last cycle (i.e., the last time when the operations of the first extracting unit 4041, the fourth acquisition unit 4042 and the detection unit 4043 are repeated) as the currently highest enhancement layer when the sum of said bit rates is larger than said currently expected bit rate.

The second transmitting module 405 is used for sending the video data to be transmitted subsequently (i.e., the video data of the next segment to be transmitted) corresponding to said currently highest enhancement layer, all the enhancement layers lower than said currently highest enhancement layer, and the base layer to the terminal device.

Then, the analysis module 403 determines the currently expected bit rate according to the transmission status of the video data sent by the second transmitting module 405 to the terminal device on the currently used channel. In other words, the first acquisition unit 4031 acquires the data volume sent by the second transmitting module 405 within the set time on the currently used channel; the second acquisition unit 4032 acquires the playback time according to the data volume sent within said set time; the third acquisition unit 4032 acquires said currently expected bit rate according to said set time and said playback time; the acquisition module 404 acquires the currently highest enhancement layer according to said currently expected bit rate determined by the analysis module 403; and the second transmitting module 405 send the video data under said currently highest enhancement layer acquired by the acquisition module 404 to the terminal device. Cycles are repeated in this way to achieve the purpose of video quality adjustment in real time.

Wherein, said acquisition module further includes an enhancement layer number setting module (not shown), which is connect to the first extracting unit 4041, for setting the layer number of the enhancement layer with the lowest layer number from all the enhancement layers which have not been extracted as 1, i.e., setting the layer number of the enhancement layer with the lowest layer number from all the enhancement layers which have not been extracted as the enhancement layer 1. Then, the first extracting unit 4041, the fourth acquisition unit 4042, the detection unit 4043 and the second extracting unit 4044 start acquiring the currently highest enhancement layer so as to clear the layer number of the enhancement layer extracted in the last cycle (i.e., the last time when repeating the operations of the analysis module 403, acquisition module 404 and the second transmitting module 405) to prevent the situation that the highest enhancement layer corresponding to the video data of next segment to be transmitted cannot be obtained if the current channel condition when sending the video data of next segment is worse than that when sending the video data of previous segment.

The apparatus for controlling video quality fluctuation based on the scalable video coding provided by the embodiment of the present invention is capable of monitoring the data transmission status within the set time period during the process of sending the video data, and dynamically predicting the maximum bit rate that can be carried by the currently used channel, and making corresponding adjustments to the currently highest enhancement layer can be transmitted so as to control the video quality specifically. Compared with the prior arts, the embodiment of the present invention is able to actively anticipate changes of channel environment, and precisely adjust the transmitted video quality according to the specific condition of changes of network bandwidth, so as to address the video quality fluctuation caused by sudden changes of bandwidth, and control the video quality fluctuation more precisely to improve the user experience.

Those skilled in the art can appreciate that all or parts of the processes of methods in above embodiments can be achieved by using computer programs to instruct relevant hardware, said programs can be stored in a computer readable storage medium. When executing the programs, processes of embodiments of various methods as described above can be included. Said storage medium can be floppy disc, compact disc, read-only memory (ROM) or random access memory (RAM), etc.

What are described above are merely detailed embodiments of the present invention, but not used to limit the scope of protection of the present invention as such. Any variation or replacement that a person skilled in the art would easily think of within the technical scope disclosed by the present invention should be covered by the scope of protection of the present invention. Therefore, the scope of protection of the present invention should be defined by the scope of protection of the claims.

What is claimed is:

1. A method for controlling video quality fluctuation based on a scalable video coding, comprising:
performing the scalable video coding on video data to be transmitted, and generating one base layer and at least one enhancement layer;
sending the video data to be transmitted after the scalable video coding to a terminal device;
determining a currently expected bit rate according to the transmission status of the video data sent to the terminal device on a currently used channel, said currently expected bit rate being the predicted maximum data transmission bit rate that can be carried by the currently used channel;
acquiring a currently highest enhancement layer according to said currently expected bit rate, the sum of all bit rates occupied when transmitting the video data under said currently highest enhancement layer being no larger than said currently expected bit rate; and
sending the video data under said currently highest enhancement layer to the terminal device.

2. The method for controlling video quality fluctuation based on the scalable video coding according to claim 1, characterized in that, the process of determining the currently expected bit rate according to the transmission status of said video data to be transmitted on the currently used channel is periodical, the method for periodically determining the currently expected bit rate includes:
acquiring a data volume sent through the currently used channel within a set time;
acquiring a playback time according to the data volume sent within said set time, said playback time being a time duration of the video playback by the terminal device according to the video data sent within said set time; and
acquiring said currently expected bit rate according to said set time and said playback time.

3. The method for controlling video quality fluctuation based on the scalable video coding according to claim 2, characterized in that, said acquiring the data volume sent through the currently used channel within the set time includes:
counting the sent data volume, and determining a counting start time; and
determining a current time, and acquiring the data volume sent within said set time, said set time being a period from said counting start time to said current time.

4. The method for controlling video quality fluctuation based on the scalable video coding according to claim 2, characterized in that, said acquiring said currently expected bit rate according to said set time and said playback time includes:
acquiring a system output value according to the ratio of the set time to the playback time;
acquiring said currently expected bit rate according to said system output value and a current data transmission bit rate.

5. The method for controlling video quality fluctuation based on the scalable video coding according to claim 4, characterized in that, said acquired currently expected bit rate is the product of the system output value and the current data transmission bit rate.

6. The method for controlling video quality fluctuation based on the scalable video coding according to claim 1, characterized in that, the video data under said currently highest enhancement layer includes:
the sum of the video data corresponding to said currently highest enhancement layer, all the enhancement layers lower than said currently highest enhancement layer and the base layer;
said method for acquiring the currently highest enhancement layer according to said currently expected bit rate includes:
1) extracting an enhancement layer with the lowest layer number from all the enhancement layers which have not been extracted;
2) acquiring the sum of the bit rates occupied when transmitting the sum of the video data corresponding to said base layer and all the extracted enhancement layers;
3) detecting whether the sum of said bit rates is larger than said currently expected bit rate or not;
if the sum of said bit rates is no larger than said currently expected bit rate, repeating the steps 1) to step 3) periodically until the sum of said bit rates is detected to be larger than said currently expected bit rate; and
4) if the sum of said bit rates is larger than said currently expected bit rate, the enhancement layer with the lowest layer number extracted from all the enhancement layers which have not been extracted in the last cycle being selected as the currently highest enhancement layer.

7. The method for controlling video quality fluctuation based on the scalable video coding according to claim 6, characterized in that, in the method for acquiring the currently highest enhancement layer according to said currently expected bit rate, it further includes the following step before the step 1): setting the layer number of the enhancement layer with the lowest layer number among all the enhancement layers which have not been extracted as 1.

8. An apparatus for controlling video quality fluctuation based on the scalable video coding, comprising:
a coding module, for performing the scalable video coding on video data to be transmitted, and generating one base layer and at least one enhancement layer;
a first transmitting module, for sending the video data to be transmitted after the scalable video coding to a terminal device;
an analysis module, for determining a currently expected bit rate according to the transmission status of the video data sent to the terminal device on a currently used channel, said currently expected bit rate being the predicted maximum data transmission bit rate that the can be carried by the currently used channel;
an acquisition module, for acquiring a currently highest enhancement layer according to said currently expected bit rate, the sum of all bit rates occupied when transmitting the video data under said currently highest enhancement layer being no larger than said currently expected bit rate; and
a second transmitting module, for sending the video data under said currently highest enhancement layer to the terminal device.

9. The apparatus for controlling video quality fluctuation based on the scalable video coding according to claim 8, characterized in that, the process of determining by the analysis module the currently expected bit rate according to the transmission status of said video data to be transmitted on the currently used channel is periodical, and said analysis module includes:
a first acquisition unit, for acquiring a data volume sent through the currently used channel within a set time;
a second acquisition unit, for acquiring a playback time according to the data volume sent within said set time, said playback time being a time duration of the video playback by the terminal device according to the video data sent within said set time;
a third acquisition unit, for acquiring said currently expected bit rate according to said set time and said playback time.

10. The apparatus for controlling video quality fluctuation based on the scalable video coding according to claim 9, characterized in that, said first acquisition unit includes:
a first timing sub unit, for determining a counting start time during the process of counting the sent data volume;
a second timing sub unit, for determining a current time, said set time being a period from said counting start time to said current time;
a counting sub unit, for acquiring the data volume sent within said set time.

11. The apparatus for controlling video quality fluctuation based on the scalable video coding according to claim 9, characterized in that, said third acquisition unit includes:
a first acquisition sub unit, for acquiring a system output value according to the ratio of the set time to the playback time;
a second acquisition sub unit, for acquiring said currently expected bit rate according to said system output value and a current data transmission bit rate.

12. The apparatus for controlling video quality fluctuation based on the scalable video coding according to claim 11, characterized in that, said currently expected bit rate acquired by the second acquisition sub unit is the product of the system output value and the current data transmission bit rate.

13. The apparatus for controlling video quality fluctuation based on the scalable video coding according to claim 8, characterized in that, the video data under said currently highest enhancement layer includes:
the sum of the video data corresponding to said currently highest enhancement layer, all the enhancement layers lower than said currently highest enhancement layer and the base layer;
said acquisition module includes:
a first extracting unit, for extracting an enhancement layer with the lowest layer number from all the enhancement layers which have not been extracted;
a fourth acquisition unit, for acquiring the sum of the bit rates occupied when transmitting the sum of the video data corresponding to said base layer and all the extracted enhancement layers;
a detection unit, for detecting whether the sum of the bit rates is larger than said currently expected bit rate or not;
if the sum of said bit rates is no larger than said currently expected bit rate, repeating the operations of the first extracting unit, the fourth acquisition unit and the detection unit periodically until the sum of said bit rates is detected to be larger than said currently expected bit rate; and
a second extracting unit, for selecting the enhancement layer with the lowest layer number extracted from all the enhancement layers which have not been extracted in the last cycle as the currently highest enhancement layer when the sum of said bit rates is larger than said currently expected bit rate.

14. The apparatus for controlling video quality fluctuation based on the scalable video coding according to claim 13, characterized in that, said acquisition module further includes:
an enhancement layer number setting module connected to the first extracting unit, for setting the layer number of the enhancement layer with the lowest layer number among all the enhancement layers which have not been extracted as 1.
